(19) United States
(12) Patent Application Publication
(10) Pub. No.: US 2012/0106400 A1
(43) Pub. Date: May 3, 2012

(54) HOME NETWORK ENABLED ANSWERING SERVICE

(75) Inventor: Mahfuzur RAHMAN, San Jose, CA (US)

(73) Assignee: SAMSUNG ELECTRONICS CO., LTD., Suwon City (KR)

(21) Appl. No.: 13/095,092

(22) Filed: Apr. 27, 2011

Related U.S. Application Data
(60) Provisional application No. 61/408,542, filed on Oct. 29, 2010.

(51) Int. Cl. H04L 12/16; H04L 12/66

(52) U.S. Cl. 370/259; 370/352

(57) ABSTRACT

In a first embodiment of the present invention, a method for handling an incoming call for home network telephony is provided, the method comprising: receiving an incoming call at a device in a home network, the incoming call including identifications of a caller and a callee; sending an incoming call notification to a plurality of home network telephony control points in the home network; and if none of the plurality of home network telephony control points in the home network answer the incoming call, retrieving a greeting recorded by the callee and causing the greeting to be played to the caller.

### CROSS REFERENCE TO RELATED APPLICATIONS

This application claims the benefit of priority under 35 U.S.C. 119(e) to U.S. Provisional Patent Application No. 61/408,542, filed Oct. 29, 2010, which is incorporated herein by reference for all purposes.

### BACKGROUND OF THE INVENTION

1. Field of the Invention

The present invention relates generally to home networking. More specifically, the present invention relates to a home network enabled answering service for IP telephony.

2. Description of the Related Art

Home networking has advanced from the early days of merely linking computers and printer to the modern home network, which can include mobile devices, televisions, set-top boxes, refrigerators, etc.

Universal Plug and Play (UPnP) is a distributed, open networking architecture that allows devices to connect seamlessly and to simplify the implementation of networks in the home (data sharing, communications, and entertainment) and corporate environments. UPnP achieves this by defining and publishing UPnP device control protocols built upon open, Internet-based communication standards.

UPnP has grown in popularity of late in part due to the rise in popularity of media servers. Media servers are small computers that store multiple types of content (e.g., photos, music, videos, etc.). The content may then be streamed from a media server to one or more control points (e.g., iPod, television set, etc.).

Voice over Internet Protocol (VoIP) is a general term for a family of transmission technologies for delivery of voice communications over the Internet or other packet-switched networks. Other terms frequently encountered and synonymous with VoIP are IP telephony and Internet telephony, as well as voice over broadband, broadband telephony, and broadband phone, when the network connectivity is available over broadband Internet access.

VoIP systems usually interface with the traditional public switched telephone network (PSTN) to allow for transparent phone communications worldwide. VoIP can be a benefit for reducing communication and infrastructure costs by routing phone calls over existing data networks and avoiding duplicate network systems. Skyp™ and Vonage™ are notable service provider examples that have achieved widespread user and customer acceptance and market penetration.

Voice-over-IP systems carry telephony speech as digital audio, typically reduced in data rate using speech data compression techniques, packetized in small units of typically tens of milliseconds of speech, and encapsulated in a packet stream over IP.

The Session Initiation Protocol (SIP) is a VoIP signaling protocol, widely used for setting up and tearing down multimedia communication sessions such as voice and video calls over the Internet. The protocol can be used for creating, modifying and terminating two-party (unicast) or multiparty (multicast) sessions consisting of one or several media streams. The modification can involve changing addresses or ports, inviting more participants, adding or deleting media streams, etc.

SIP clients typically use TCP or UDP (typically on port 5060 and/or 5061) to connect to SIP servers and other SIP endpoints. SIP is primarily used in setting up and tearing down voice or video calls.

A motivating goal for SIP was to provide a signaling and call setup protocol for IP-based communications that can support a superset of the call processing functions and features present in the public switched telephone network (PSTN). SIP by itself does not define these features; rather, its focus is call-setup and signaling. However, it was designed to enable the construction of functionalities of network elements designated Proxy Servers and User Agents. These are features that permit familiar telephone-like operations: dialing a number, causing a phone to ring, hearing ringback tones or a busy signal. Implementation and terminology are different in the SIP world but to the end-user, the behavior is similar.

SIP-enabled telephony networks can also implement many of the more advanced call processing features present in Signaling System 7 (SS7), though the two protocols themselves are very different. SS7 is a centralized protocol, characterized by a complex central network architecture and dumb endpoints (traditional telephone handsets). SIP is a peer-to-peer protocol, thus it requires only a simple (and thus scalable) core network with intelligence distributed to the network edge, embedded in endpoints (terminating devices built in either hardware or software). SIP features are implemented in the communicating endpoints (i.e. at the edge of the network) contrary to traditional SS7 features, which are implemented in the network.

Recently, VoIP has been extended to mobile devices such as cellular phones. There are several methodologies by which a mobile handset can be integrated into a VoIP network. One implementation turns the mobile device into a standard SIP client, which then uses a data network to send and receive SIP messaging, and to send and receive RTP for the voice path. This methodology of turning a mobile handset into a standard SIP client requires that the mobile handset support, at minimum, high speed IP communications. In this application, standard VoIP protocols (typically SIP) can be used over any broadband IP-capable wireless network connection.

As UPnP grows in popularity, more and more devices in the home are going to be networked. If these devices all have the capability to perform various telephony-related tasks through the UPnP protocol, then it is desirable to make the telephony aspects of these devices as easy to use as possible. Specifically, it is beneficial to offer the same type of services that more traditional telephone devices offer, including answering services. While UPnP contains specifications to manage incoming and outgoing calls, there is no mechanism to address answering services when an incoming call is notified to the UPnP devices but none of the devices accept the call.

### SUMMARY OF THE INVENTION

In a first embodiment of the present invention, a method for handling an incoming call for home network telephony is provided, the method comprising: receiving an incoming call at a device in a home network, the incoming call including identifications of a caller and a callee; sending an incoming call notification to a plurality of home network telephony control points in the home network; and if none of the plurality of home network telephony control points in the home network answer the incoming call, retrieving a greeting recorded by the callee and causing the greeting to be played to the caller.

In a second embodiment of the present invention, a home network telephony server is provided, comprising: means for receiving an incoming call from a caller outside of a home network, the incoming call including identifications of the caller and a callee; means for sending an incoming call notification to a plurality of home network telephony control points in the home network; and means for, if none of the plurality of home network telephony control points in the home network answer the incoming call, retrieving a greeting recorded by the callee and causing the greeting to be played to the caller; means for recording a voice mail message from the caller; means for causing the voice mail message from the caller to be stored in the home network outside of the home network telephony server; and means for sending a multicast event message to all home network telephony control points in the home network regarding the existence of the voice mail message.

In a third embodiment of the present invention, a home network telephony voice mail system is provided, comprising: a telephony server including an answering feature; a plurality of telephony control points; a content storage device; and a CDS; wherein the telephony server is designed to, upon receipt of a recorded voice mail, cause the recorded voice mail to be stored in either the content storage device or the CDS and send an event to the plurality of telephony control points informing them of the existence of the recorded voice mail.

In a third embodiment of the present invention, a non-transitory program storage device readable by a machine tangibly embodying a program of instructions executable by the machine to perform a method for handling an incoming call for home network telephony is provided, the method comprising: receiving an incoming call at a device in a home network, the incoming call including identifications of a caller and a callee; sending an incoming call notification to a plurality of home network telephony control points in the home network; and if none of the plurality of home network telephony control points in the home network answer the incoming call, retrieving a greeting recorded by the callee and causing the greeting to be played to the caller.

### BRIEF DESCRIPTION OF THE DRAWINGS

FIG. 1 is a diagram illustrating an architecture for providing a networked answering service in accordance with an embodiment of the present invention.

FIG. 2 is a diagram illustrating the same architecture of FIG. 1 except used to store voice mails in accordance with an embodiment of the present invention.

FIG. 3 is a diagram illustrating the architecture of FIG. 1 being used to retrieve voice mail in accordance with an embodiment of the present invention.

FIG. 4 is a diagram illustrating a block diagram of the process of playing a recorded greeting in accordance with an embodiment of the present invention.

FIG. 5 is a flow diagram illustrating a method for handling an incoming call for home network telephony in accordance with an embodiment of the present invention.

FIG. 6 is a high level block diagram showing a computer system in accordance with an embodiment of the present invention.

### DETAILED DESCRIPTION OF SPECIFIC EMBODIMENTS

Reference will now be made in detail to specific embodiments of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the following description, specific details are set forth in order to provide a thorough understanding of the present invention. The present invention may be practiced without some or all of these specific details. In addition, well known features may not have been described in detail to avoid unnecessarily obscuring the invention.

In accordance with the present invention, the components, process steps, and/or data structures may be implemented using various types of operating systems, programming languages, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein. The present invention may also be tangibly embodied as a set of computer instructions stored on a computer readable medium, such as a memory device.

An embodiment of the present invention supports a networked answering service that answers incoming calls when no telephony devices within a home network answer the call. The concept of a home network answering service is introduced, where media objects to be played back are located in different devices in the home network. Additionally, the recorded voice mail can be stored in different devices based on preferences set in a telephony server, including in a content directory service (CDS). Furthermore, a notification mechanism can be provided where a recorded voice mail is notified to subscribed UPnP telephony devices. Furthermore, authentication may be provided to retrieve voicemail from a distributed environment. An embodiment of the present invention additionally enables a CDS media object to be played back by a telephony server to the call to answer an incoming call made available through the UPnP network. Finally, an embodiment of the present invention enables a telephony service to be configured to play different media objects to answer a call depending on the call.

In another embodiment of the present invention, the voicemail is stored outside of the home network, by the service provider (in the Wide Area Network). Notifications can then be sent by the telephony server to all the control points in the home network with details of the voice mail and how it may be retrieved. The control point can retrieve the voice mail from the telephony server through a media session, who then retrieves it from the service provider through a media session. Alternatively, the telephony server may provide a URL to retrieve the voicemail during the notification. The control point can then retrieve the voice mail by accessing the URL.

It should be noted that the term “home networking” as used throughout this document refers to a type of network that is commonly used in homes to connect media devices. There is no requirement, however, that this type of networking actually be used in homes, as it has equal applicability for use in businesses or other entities. As such, the term “home networking” shall not be construed as limiting any embodiments of the present invention to use in a home, and shall be interpreted as any type of local area network (LAN).

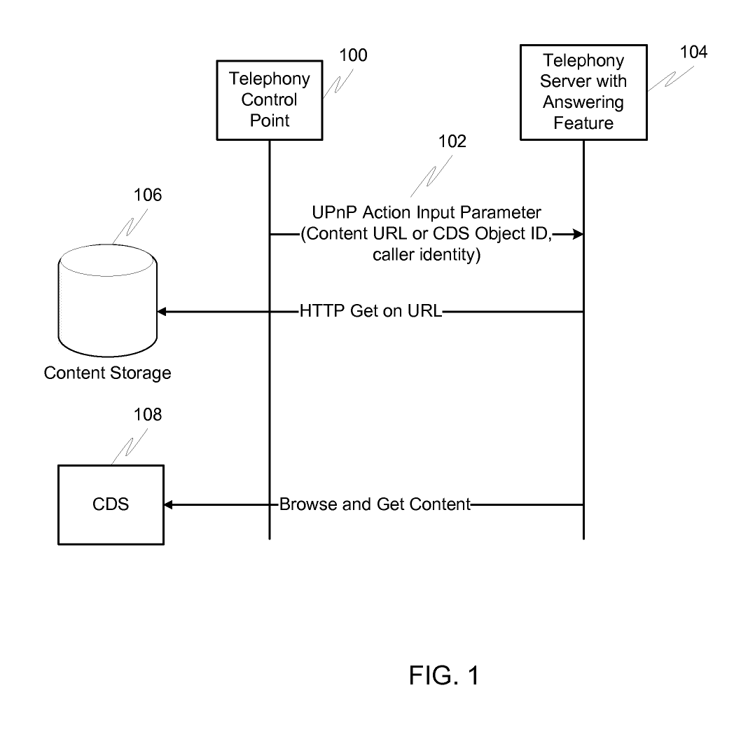

FIG. 1 is a diagram illustrating an architecture for providing a networked answering service in accordance with an embodiment of the present invention. Here, a telephony control point 100 resides on one or more UPnP devices within a home network. The telephony control point 100 performs a UPnP action 102 on a telephony server 104 in the home network. It should be noted that in some embodiments, it may be possible that the answering service is located on a device or component other than telephony server, in which case the UPnP action will be performed on that device or component. However, in this embodiment the answering service is located on the telephony server 104. It should also be noted that this embodiment describes the answering service as a “feature” of the server. This term is intended to be interpreted broadly to encompass any code, module, or component integrated in or controlled by the telephony server.

A telephony server is a home networking server that acts as a central point for incoming (and possibly outgoing) telephone calls. Typically, each telephony server will represent a single phone number that can be shared among multiple devices in the home network (and multiple users as well). Typically, a separate phone number will be referred to as a separate telephony server, although from an architecture standpoint both “servers” may reside on a single physical device.

A telephony server typically has a Uniform Resource Identifier (URI) or similar mechanism for identifying its location. In SIP environments, this may be a SIP URI. This URI can be used either alone to reference all users of the telephony server, or may be appended to a user name to identify an individual user of the telephone line. It should be noted that there may be other mechanisms used to identify an individual user of the telephony line, and a SIP URI appended to a user name is merely one example.

The input argument of the action to the answering service can include the address of the media (typically in the form of a Uniform Resource Locator (URL)) to be used for playing back (i.e., the “recorded greeting” typical of voice mail systems). Alternatively, the input argument can include a CDS object identifier for the media. The input argument can also contain the identity of the caller. The particular media content can be played back when the telephony server receives a call from the caller with that particular identity. In this manner, a user operating a telephony control point 100 can not only record and set up a greeting for incoming callers, but can tailor different greetings for different callers. Since the input argument contains the location or other information about how to retrieve the greeting, the greeting can actually be stored anywhere in the home network.

In one embodiment of the present invention, the caller argument could be a null value. This means that the media content will be used to playback for all callers when the call is not answered.

It is also possible to use a list of caller IDs and media content IDs in the input argument.

In one embodiment of the present invention, the telephony server may retrieve the content and keep it in the local storage for playback, rather than retrieve it only when a call comes in.

The telephony server 104 can send an HTTP Get on the appropriate URL to retrieve the media content (recorded greeting) from content storage 106. Content storage 106 may be stored anywhere in the home network. Alternatively, the media content can be stored in a CDS 108 and browsed by the telephony server through typical CDS interactions. CDS interactions will not be discussed in this document as they are outside the scope of the disclosure.

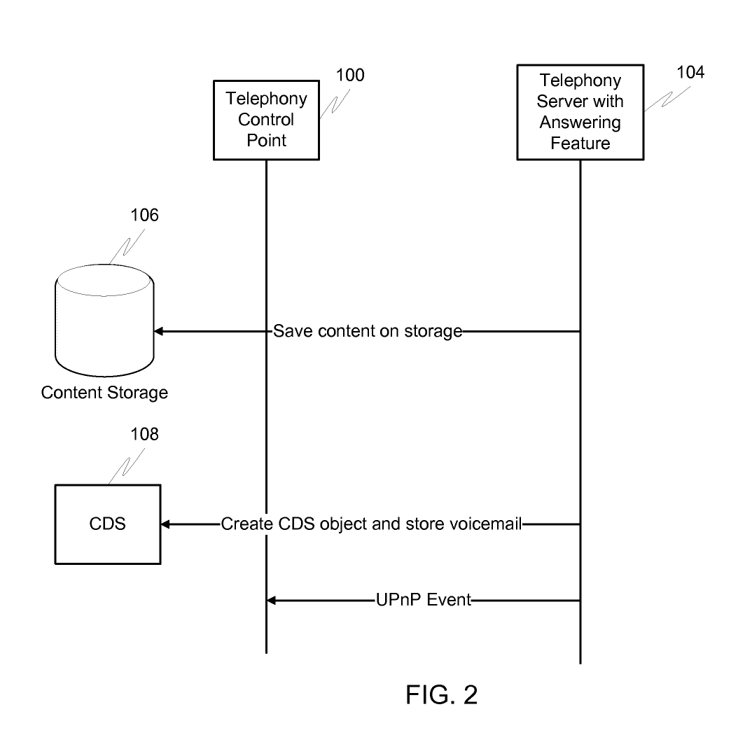

FIG. 2 is a diagram illustrating the same architecture of FIG. 1 except used to store voice mails in accordance with an embodiment of the present invention. Once a caller leaves a message, this message may be stored in content storage 106. Alternatively, the telephony server 104 can create a CDS object and store the voice mail in the CDS 108. The telephony server keeps track of voicemail locations (e.g., URLs) and all other metadata related to the voice mails, such as date, time, caller, etc. The telephony server 104 may also send a UPnP event with the stored voice mail address and caller identity to the telephony control point 100, allowing the user of the telephony control point 100 to be alerted to the fact that a voice mail message is waiting to be retrieved. For privacy reasons, in some embodiments the location of the stored voice mail may not be included in the UPnP event.

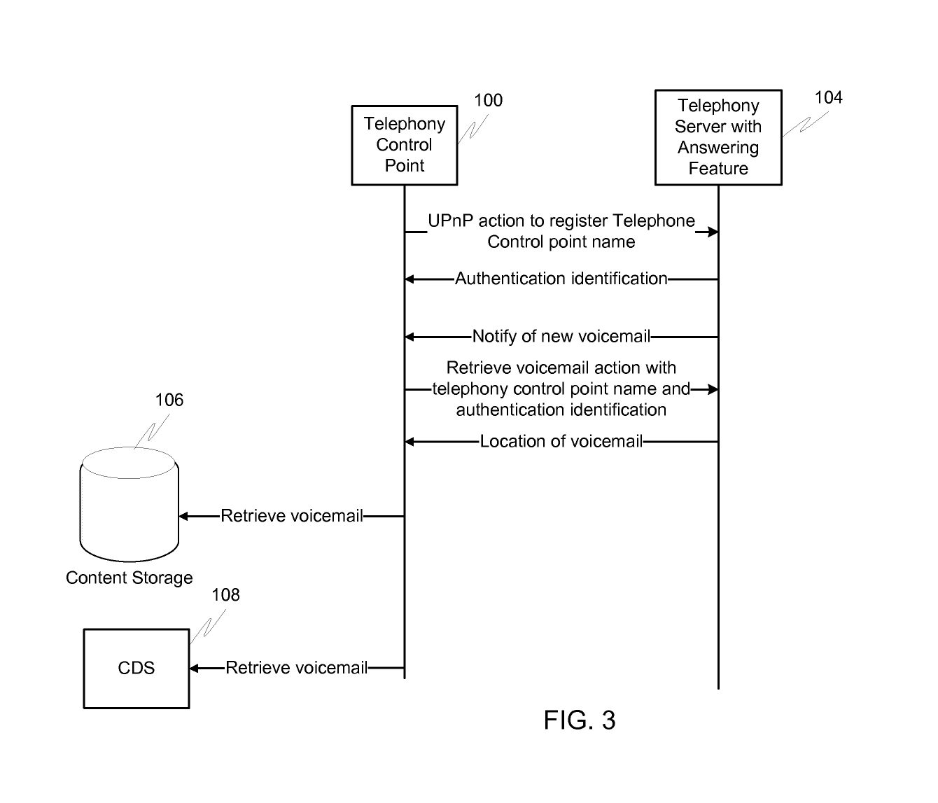

Retrieving the voicemail may be reserved for only authorized users. For example, it may be desirable to limit a voice mail message left for a specific user to only be retrieved by that user. FIG. 3 is a diagram illustrating the architecture of FIG. 1 being used to retrieve voice mail in accordance with an embodiment of the present invention. Here, the telephony control point 100 registers with the telephony server 104. This registration includes its name, and the telephony server 104 may then issue an authentication identification to the telephony control point 100. When the telephony control point 100 receives a UPnP notification of a new voice mail message (as described with respect to FIG. 2, above), the body of the UPnP notification can include an indication of which user the message has been left for. The control point 100 then may check a stored mapping between this indicated user and authentication identifications. If there is a match, then it invokes an action and supplies the corresponding stored authentication identification to the telephony server 104. The telephony server 104 then verifies the authentication identification, and if it is valid, the telephony server 104 accepts the action. The voice mail itself can be encrypted to provide further security, and the voice mail retrieve action that is invoked by the telephony control point 100 can return the password to decrypt the encrypted content.

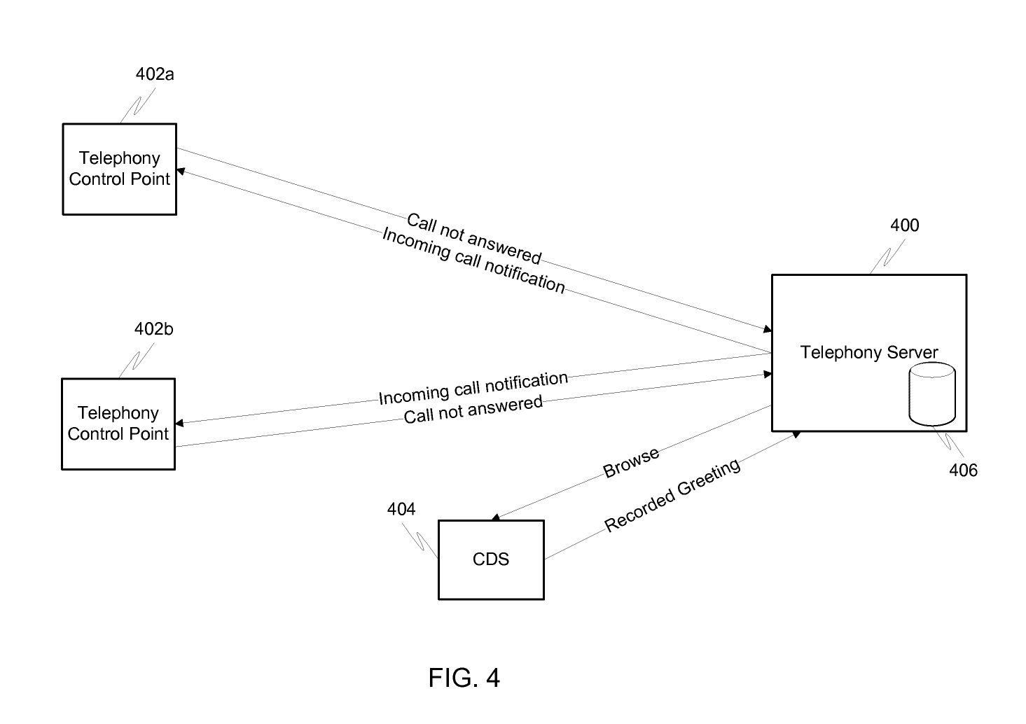

FIG. 4 is a diagram illustrating a block diagram of the process of playing a recorded greeting in accordance with an embodiment of the present invention. Here, incoming calls are received at the telephony server 400. The telephony server then sends an incoming call notification to UPnP control points 402a, 402b. In some embodiments, this incoming call notification is multicast to all UPnP control points in the home network. In other embodiments, the telephony server may send the notification in a more refined manner. For example, if presence information is available to the telephony server, then the telephony server may be aware of which device or devices the callee is currently associated with. The telephony server may then take steps to only notify the devices the callee is currently associated with. Thus, if Joe is watching television in the living room, notification of an incoming call for Joe may be directed only to home network devices in the living room, not in the bedroom, for example.

If the call is not answered at any of the UPnP control points 402a, 402b, then the telephony server 400 browses a CDS 404 for playback content, and retrieves the playback content to play the greeting for the caller. It should be noted that this figure only depicts the implementation where CDS is used to store the greeting. As described above, embodiments are possible where CDS is not used, and the greeting is simply stored in content storage somewhere in the network. Additionally, as described above, it is possible that the UPnP telephony server 400 will have proactively retrieved the playback content before the incoming call arrives, storing the playback content in local storage 406.

It should also be noted that embodiments are foreseen wherein both the greeting and the recorded voice mail are videos rather than merely audio files. This allows the system to handle greetings and messages that would normally be accessed in video calls, rather than being limited to more traditional audio-only telephony.

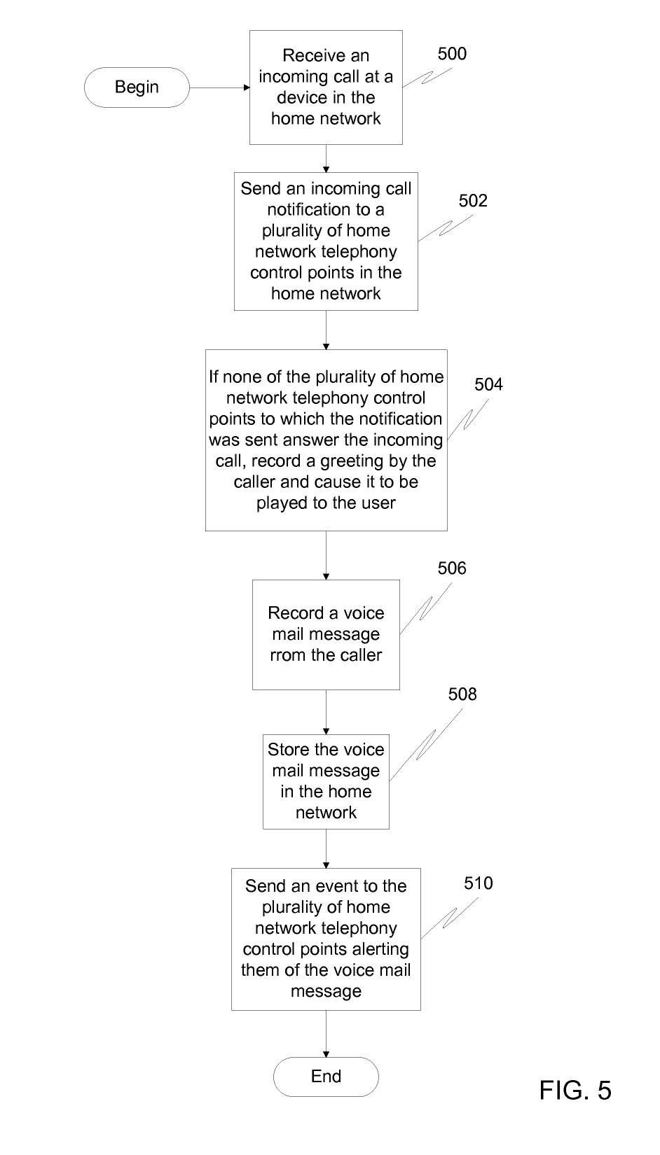

FIG. 5 is a flow diagram illustrating a method for handling an incoming call for home network telephony in accordance with an embodiment of the present invention. At 500, an incoming call is received at a device in the home network, the incoming call including identifications of a caller and a callee. The device may be a telephony server having answering service functionality. In response to the incoming call, at 502 the device sends an incoming call notification to a plurality of home network telephony control points in the home network. At 504, if none of the plurality of home network telephony control points to which the notification was sent answer the incoming call, a greeting recorded by the caller is retrieved and caused to be played to the user. This retrieving may be performed by accessing a mapping between callees and greeting locations and fetching the stored greeting from the location corresponding to the callee of the in coming call. This greeting location may be, for example, in a local storage of the device, a URL identifying a location in content storage somewhere in the home network, or an identification of a CDS object storing the greeting. The greeting may be audio-only or may be a video greeting including both video and audio portions.

In some embodiments, there are a plurality of different greetings recorded for a single callee. These greetings may be distinguished by caller, and thus the mapping may include not just a mapping between callees and greeting locations but also between callers, callees, and greeting locations.

At 506, a voice mail message may be recorded from the caller. At 508, the voice mail message may be stored in the home network. As with the greeting, this voice mail message may be stored in local storage, content storage somewhere else in the home network, or as a CDS object. At 510, an event may be sent to the plurality of home network telephony control points alerting them of the voice mail message. In some embodiments of the present invention, the event includes a location of the stored voice mail message. In other embodiments, for privacy purposes, the event does not include a location of the stored voice mail message. In these embodiments, the location of the stored voice mail message is only provided to a home network telephony control point if an authentication identification authenticating the home network telephony control point is provided and verified. This may be performed using a mapping between home network telephony control points and authentication identifications, which is set up when each home network telephony control points registers with the telephony server.

It should also be noted that while the above embodiments discuss actions taken when no device answers a call, there may be other events that trigger the playing of a recorded greeting the recording of a voice mail. For example, if there is a mechanism to detect that the desired user is already on a phone call, then the voice mail system may be activated just as if the call had gone unanswered. Such an embodiment is largely implementation-dependent, and there are certain circumstances where such an embodiment would either detract from or enhance the feeling that the user is using an “ordinary phone.” For example, many users may be accustomed to old fashion telephone systems, where a physical answering machine is present and only is activated in the case that there are four or more unanswered rings on the phone. If the user is utilizing the phone when a call arrives, that call is either returned with a busy signal, or a “call waiting” feature is identified allowing the user to place the current phone call on hold to answer the new call. However, other customers may be accustomed to newer phone systems, especially mobile phone systems, that send a call directly to voice mail if the phone is in use when the call arrives.

Information transferred between telephony control points and telephony servers may be in the form of signals such as electronic, electromagnetic, optical, or other signals capable of being received by ac communications interface, via a communication link that carries signals and may be implemented using wire or cable, fiber optics, a phone line, a cellular phone link, a radio frequency link, and/or other communication channels. It should be noted that program storage devices, as may be used to describe storage devices containing executable computer code for operating various methods of the present invention, shall not be construed to cover transitory subject matter, such as carrier waves or signals. Program storage devices and computer readable medium are terms used generally to refer to media such as main memory, secondary memory, removable storage disks, hard disk drives, and other tangible storage devices or components.

As will be appreciated to one of ordinary skill in the art, the aforementioned example architectures can be implemented in many ways, such as program instructions for execution by a processor, as software modules, microcode, as computer program product on computer readable media, as logic circuits, as application specific integrated circuits, as firmware, as consumer electronic device, etc. and may utilize wireless devices, wireless transmitters/receivers, and other portions of wireless networks. Furthermore, embodiment of the disclosed method and system for displaying multimedia content on multiple electronic display screens can take the form of an entirely hardware embodiment, an entirely software embodiment, or an embodiment containing both software and hardware elements.

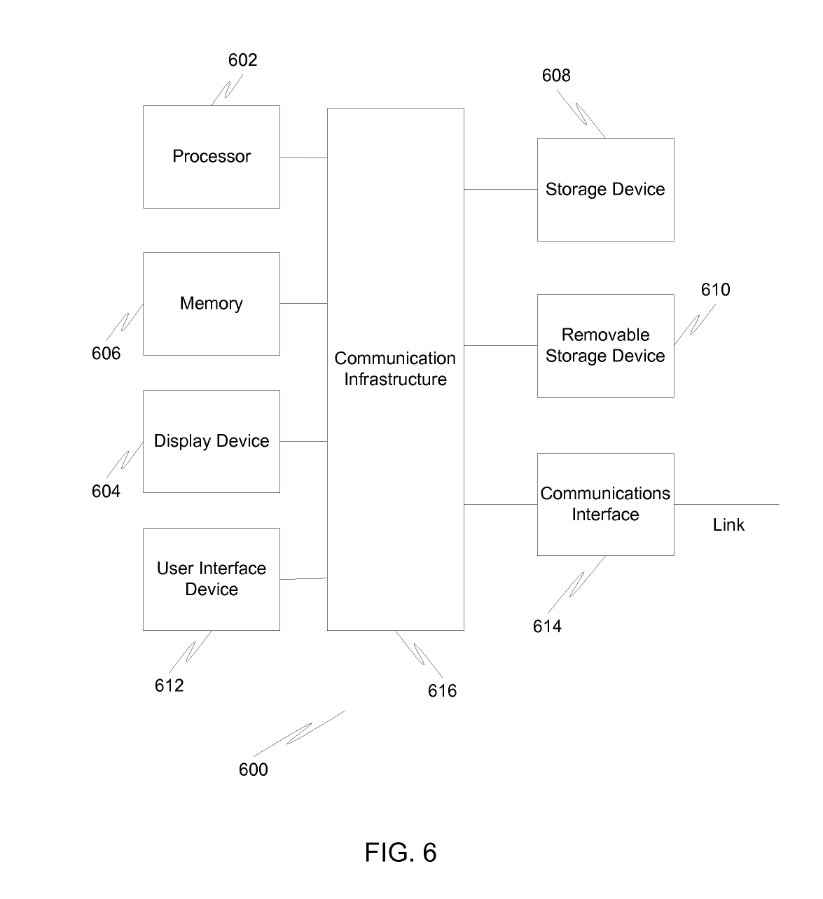

FIG. 6 is a high level block diagram showing a computer system in accordance with an embodiment of the present invention. The computer system 600 is useful for implementing an embodiment of the disclosed invention. The computer system 600 includes one or more processors 602, and further can include an electronic display device 604 (for displaying graphics, text, and other data), a main memory 606 (e.g., random access memory (RAM)), storage device 608 (e.g., hard disk drive), removable storage device 610 (e.g., optical disk drive), user interface devices 612 (e.g., keyboards, touch screens, keypads, mice or other pointing devices, etc.), and a communication interface 614 (e.g., wireless network interface). The communication interface 614 allows software and data to be transferred between the computer system 600 and external devices via a link. The system may also include a communications infrastructure 616 (e.g., a communications bus, cross-over bar, or network) to which the aforementioned devices/modules are connected.

Information transferred via communications interface 614 may be in the form of signals such as electronic, electromagnetic, optical, or other signals capable of being received by communications interface 614, via a communication link that carries signals and may be implemented using wire or cable, fiber optics, a phone line, a cellular phone link, a radio frequency link, and/or other communication channels. It should be noted that program storage devices, as may be used to describe storage devices containing executable computer code for operating various methods of the present invention, shall not be construed to cover transitory subject matter, such as carrier waves or signals. Program storage devices and computer readable medium are terms used generally to refer to media such as main memory, secondary memory, removable storage disks, hard disk drives, and other tangible storage devices or components.

The term “computer readable medium” is used generally to refer to media such as main memory, secondary memory, removable storage, hard disks, flash memory, disk drive memory, CD-ROM and other forms of persistent memory. It should be noted that program storage devices, as may be used to describe storage devices containing executable computer code for operating various methods of the present invention, shall not be construed to cover transitory subject matter, such as carrier waves or signals. Program storage devices and computer readable medium are terms used generally to refer to media such as main memory, secondary memory, removable storage disks, hard disk drives, and other tangible storage devices or components.

Although only a few embodiments of the invention have been described in detail, it should be appreciated that the invention may be implemented in many other forms without departing from the spirit or scope of the invention. Therefore, the present embodiments should be considered illustrative and not restrictive and the invention is not to be limited to the details given herein, but may be modified within the scope and equivalents of the appended claims.

What is claimed is:

1. A method for handling an incoming call for home network telephony, the method comprising:
receiving an incoming call at a device in a home network, the incoming call including identifications of a caller and a callee;
sending an incoming call notification to a plurality of home network telephony control points in the home network; and
if none of the plurality of home network telephony control points in the home network answer the incoming call, retrieving a greeting recorded by the callee and causing the greeting to be played to the caller.

2. The method of claim 1, wherein the retrieving a greeting includes retrieving the greeting by accessing a mapping between callees and greeting locations.

3. The method of claim 2, wherein at least one of the greeting locations is in a local storage of the device.

4. The method of claim 1, wherein the device includes a telephony server.

5. The method of claim 2, wherein at least one of the greeting locations is a uniform resource locator (URL) identifying a location in content storage somewhere in the home network.

6. The method of claim 2, wherein at least one of the greeting locations is an identification of a content directory service (CDS) object storing a greeting.

7. The method of claim 2, wherein there are a plurality of different greetings for a single callee, and the retrieving a greeting includes retrieving a greeting by accessing a mapping between callers, callees, and greeting locations.

8. The method of claim 1, wherein the greeting is a video greeting.

9. The method of claim 1, further comprising:
recording a voice mail message from the caller;
storing the voice mail message on content storage somewhere in the home network;
sending an event to the plurality of home network telephony control points alerting of the voice mail message.

10. The method of claim 9, wherein the event includes a user name, allowing a telephony control point receiving the event to access detailed information regarding the voice mail message by invoking an action including the user name with authentication information.

11. The method of claim 9, wherein the event includes a location of the stored voice mail message.

12. The method of claim 9, wherein the event does not include a location of the stored voice mail message, and wherein the location of the stored voice mail message is only provided to a home network telephony control point if an authentication identification authenticating the home network telephony control point is provided.

13. The method of claim 12, wherein details of the voice mail message are retrieved by the telephony control point by invoking an action on the telephony server and providing an authentication identifier in the action request.

14. The method of claim 1, further comprising:
recording a voice mail message from the caller;
storing the voice mail message as a CDS object in a CDS;
sending an event to the plurality of home network telephony control points alerting of the voice mail message.

15. The method of claim 1, further comprising:
recording a voice mail message from the caller;
storing the voice mail message in a wide area network outside of the home network;
sending an event to the plurality of home network telephony control points alerting of the voice mail message.

16. The method of claim 15, wherein the event includes a Uniform Resource Locator (URL) for the voice mail.

17. The method of claim 15, wherein the voice mail message is retrieved by a home network telephony control point by establishing a media session between the home network telephony control point and the home network telephony server and another media session between the home network telephony server and a carrier hosting the voice mail.

18. The method of claim 11, wherein the event includes an identification of the CDS object.

18. The method of claim 11, wherein the event does not include an identification of the CDS object, and wherein the identification of the CDS object is only provided to a home network telephony control point if an authentication identification authenticating the home network telephony control point is provided.

20. A home network telephony server, comprising:
means for receiving an incoming call from a caller outside of a home network, the incoming call including identifications of the caller and a callee;
means for sending an incoming call notification to a plurality of home network telephony control points in the home network; and
means for, if none of the plurality of home network telephony control points in the home network answer the incoming call, retrieving a greeting recorded by the callee and causing the greeting to be played to the caller;
means for recording a voice mail message from the caller;
means for causing the voice mail message from the caller to be stored in the home network outside of the home network telephony server; and
means for sending a multicast event message to all home network telephony control points in the home network regarding the existence of the voice mail message.

21. The home network telephony server of claim 20, wherein the means for causing the voice mail message from the caller to be stored includes means for creating a CDS object.

22. The home network telephony server of claim 20, wherein the means for causing the voice mail message from the caller to be stored includes means for storing the voice mail message on a content storage device in the home network.

23. A home network telephony voice mail system, comprising:
a telephony server including an answering feature;
a plurality of telephony control points;
a content storage device; and
a CDS;
wherein the telephony server is designed to, upon receipt of a recorded voice mail, cause the recorded voice mail to be stored in either the content storage device or the CDS and send an event to the plurality of telephony control points informing them of the existence of the recorded voice mail.

24. The home network telephony voice mail system of claim 23, wherein the telephony server is compatible with the Universal Plug and Play (UPnP) protocol.

25. A non-transitory program storage device readable by a machine tangibly embodying a program of instructions executable by the machine to perform a method for handling an incoming call for home network telephony, the method comprising:
receiving an incoming call at a device in a home network, the incoming call including identifications of a caller and a callee;
sending an incoming call notification to a plurality of home network telephony control points in the home network; and
if none of the plurality of home network telephony control points in the home network answer the incoming call, retrieving a greeting recorded by the callee and causing the greeting to be played to the caller.

26. The non-transitory program storage device of claim 25, wherein the method is performed by a home network telephony server.

27. The non-transitory program storage device of claim 25, wherein the home network telephony server is associated with a single telephone number.
